(19) United States
(12) Patent Application Publication
(10) Pub. No.: US 2024/0097477 A1
(43) Pub. Date: Mar. 21, 2024

(54) Power Supply System

(71) Applicant: TOYOTA JIDOSHA KABUSHIKI KAISHA, Toyota-shi Aichi-ken (JP)

(72) Inventors: Hirotsugu OHATA, Susono-shi Shizuoka-ken (JP); Eiji SATOU, Miyoshi-shi Aichi-ken (JP)

(73) Assignee: TOYOTA JIDOSHA KABUSHIKI KAISHA, TOYOTA-SHI AICHI-KEN (JP)

(21) Appl. No.: 18/369,874

(22) Filed: Sep. 19, 2023

(30) Foreign Application Priority Data
Sep. 20, 2022 (JP) 2022-149360

(51) Int. Cl. H02J 7/00

(52) U.S. Cl. CPC H02J 7/007182; H02J 7/0025

(57) ABSTRACT

A power supply system includes: a plurality of battery units connected to a load in parallel with each other; and a control device that controls each of the plurality of battery units. The control device performs voltage control (first voltage control) in accordance with a voltage command (first voltage command) in a first battery unit, and performs power control in accordance with a power command in a second battery unit. The control device sets a limit value for a change in electric power in the voltage control of the first battery unit, and when a difference between an output voltage value and a command voltage value exceeds a predetermined range, performs voltage control (second voltage control) in accordance with a voltage command (second voltage command) in the second battery unit.

### CROSS REFERENCE TO RELATED APPLICATIONS

This nonprovisional application is based on Japanese Patent Application No. 2022-149360 filed on Sep. 20, 2022 with the Japan Patent Office, the entire contents of which are hereby incorporated by reference.

### BACKGROUND

### Field

The present disclosure relates to a power supply system.

### Description of the Background Art

Japanese Patent Laying-Open No. 2014-103804 discloses a battery system in which a plurality of battery packs are connected in parallel. Here, voltage control may be performed in one of the plurality of battery packs, and power control may be performed in another of the battery packs.

### SUMMARY

As described above, voltage control may be performed in one (hereinafter referred to as a first battery unit) of a plurality of battery packs, and power control may be performed in another (hereinafter referred to as a second battery unit) of the battery packs. In this case, when output power deviates from command power in the second battery unit, load on the first battery unit increases in order to suppress a variation in output voltage caused by the deviation. There is thus a desire for a system that can suppress the variation in output voltage while suppressing the increase in load on the first battery unit.

The present disclosure was made to solve such a problem, and has an object to provide a power supply system that can suppress a variation in output voltage while suppressing an increase in load on a battery unit in which power control is performed.

A power supply system according to one aspect of the present disclosure includes: a plurality of battery units connected to a load in parallel with each other and each including a battery and a converter; and a control device that controls each of the plurality of battery units. The plurality of battery units include a first battery unit and a second battery unit. The control device performs first voltage control in accordance with a first voltage command in the first battery unit, and performs power control in accordance with a power command in the second battery unit, sets a limit on a change in electric power in the first voltage control, and when a difference between an output voltage value and a command voltage value exceeds a predetermined range, performs second voltage control in accordance with a second voltage command in the second battery unit.

In the power supply system according to one aspect of the present disclosure, a limit is set on a change in electric power in the first voltage control as described above. Thus, an increase in load on the first battery unit in which the first voltage control is performed due to a change in electric power can be suppressed. Additionally, in the power supply system, when a difference between an output voltage value and a command voltage value exceeds a predetermined range, second voltage control is performed in accordance with a second voltage command in the second battery unit. Thus, even in the case where the difference exceeds the predetermined range due to the limit on a change in electric power in the first battery unit, an increase in the difference can be suppressed by the second voltage control. As a result, a variation in output voltage can be suppressed. Therefore, a variation in output voltage can be suppressed, while an increase in load on the first battery unit is suppressed as described above.

In the power supply system according to one aspect, the control device adjusts the predetermined range based on a command value of the power command. With such a configuration, even in the case where the output voltage value changes significantly and the difference changes significantly due to a change in the command value of the power command, excessive execution of the second voltage control can be suppressed since the predetermined range is adjusted.

In this case, the control device increases the predetermined range as the command value of the power command increases. With such a configuration, excessive execution of the second voltage control can be further suppressed since the predetermined range increases as the output voltage value increases due to a change in the command value of the power command.

In the power supply system according to one aspect, the control device sets the limit value by setting an upper limit and a lower limit on an amount of change in current value in the first voltage control. With such a configuration, an increase in load on the first battery unit can be readily suppressed since the upper limit and the lower limit are set on the amount of change in current value in the first voltage control.

In this case, the control device increases the predetermined range, and increases an absolute value of each of the upper limit and the lower limit, as the command value of the power command increases. With such a configuration, excessive execution of the second voltage control can be suppressed, and excessive current limitation can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows a configuration of a power supply system according to one embodiment.

FIG. 2 shows a configuration of a control device of the power supply system according to one embodiment.

FIG. 3 shows control by a current limiting unit in the control device according to one embodiment.

FIG. 4 shows control by a dead zone processing unit in the control device according to one embodiment.

FIG. 5 shows a relationship between a limit value in the current limiting unit and command power according to one embodiment.

FIG. 6 shows a relationship between a range of a dead zone in the dead zone processing unit and command power according to one embodiment.

### DESCRIPTION OF THE EMBODIMENTS

An embodiment of the present disclosure will be described in detail below with reference to the drawings. The same or corresponding portions in the drawings are denoted by the same reference characters and description thereof will not be repeated.

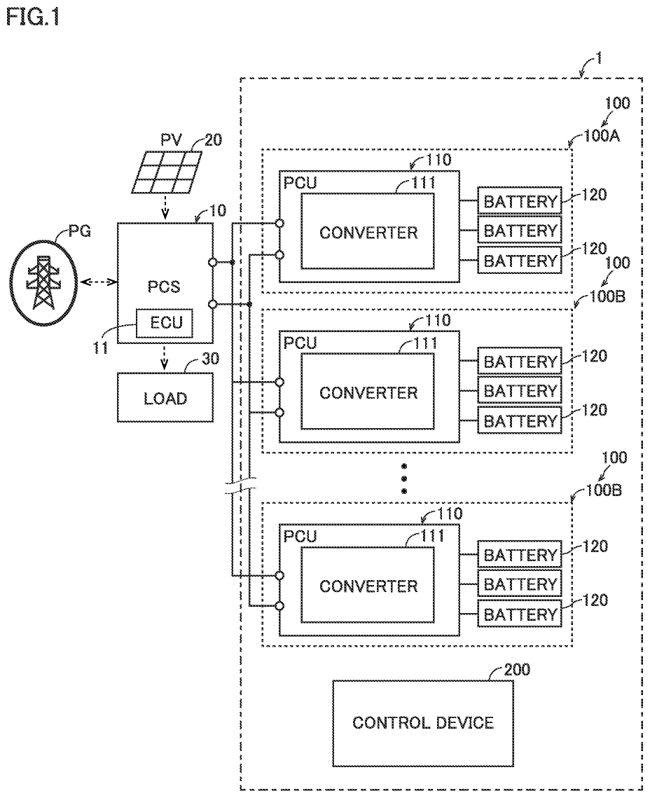

FIG. 1 shows a configuration of a power supply system 1 according to the present embodiment. Power supply system 1 includes a plurality of battery units 100 connected to a load 30 in parallel with each other. The plurality of battery units 100 are also connected to a power conditioning system (PCS) 10 in parallel with each other.

Each of the plurality of battery units 100 includes a converter 111 and a battery 120. Converter 111 is provided in a power control unit (PCU) 110. Each of the plurality of battery units 100 is provided with a plurality of batteries 120.

Converter 111 converts AC power from PCS 10 into DC power. Converter 111 also supplies the converted DC power to battery 120. Battery 120 is thus charged.

PCS 10 receives electric power from, for example, a photovoltaic apparatus 20. PCS 10 also supplies AC power to load 30. It should be noted that load 30 includes electrical appliances used in the home (for example, an air conditioner and a lighting fixture). PCS 10 also transfers electric power to and from a power system PG.

PCS 10 includes an ECU 11 that controls each of the plurality of battery units 100. ECU 11 also controls transfer of electric power to and from each of photovoltaic apparatus 20, load 30, and power system PG.

The plurality of battery units 100 include a first battery unit 100A and a second battery unit 100B. The number of first battery units 100A is one. The number of second battery units 100B is N−1. That is, the number of the plurality of battery units 100 is N. First battery unit 100A and second battery unit 100B share a common configuration.

A control device 200 performs voltage control in accordance with a voltage command in first battery unit 100A. It should be noted that the voltage command and the voltage control in first battery unit 100A are examples of “first voltage command” and “first voltage control” of the present disclosure, respectively.

On the other hand, control device 200 performs power control in accordance with a power command in second battery unit 100B. Control device 200 performs power control in each of the plurality of second battery units 100B.

Here, in a conventional power supply system, when output power deviates from command power in a second battery unit, load on a first battery unit increases in order to suppress a variation in output voltage caused by the deviation. There is a desire for a system that can suppress the variation in output voltage while suppressing the increase in load on the first battery unit.

In the present embodiment, therefore, control device 200 sets a limit value for a change in electric power in the voltage control of first battery unit 100A. Control device 200 sets the limit value by setting an upper limit and a lower limit on the amount of change in current value in the voltage control of first battery unit 100A. It should be noted that the upper limit and the lower limit are equal in absolute value to each other.

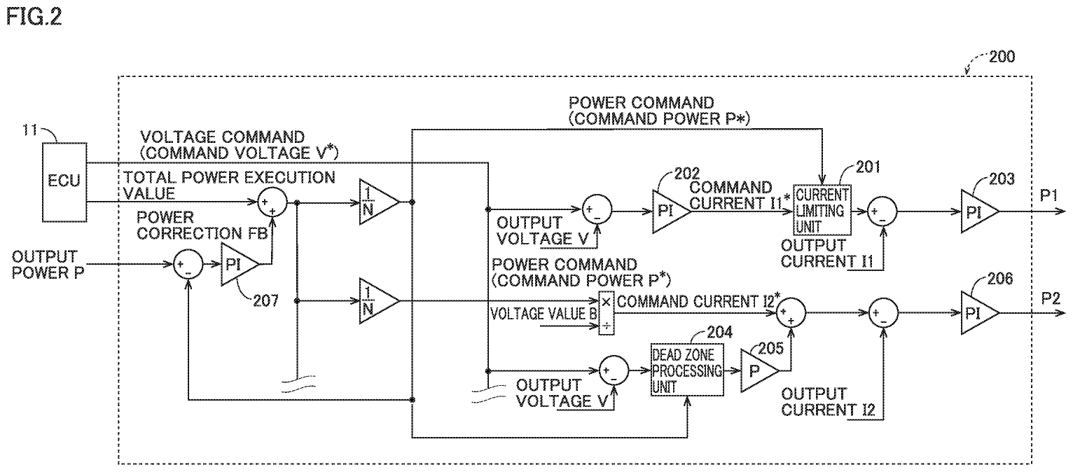

Specifically, control device 200 includes a current limiting unit 201 (see FIG. 2). As shown in FIG. 2, a signal based on a voltage command (command voltage V*) from ECU 11 is input to current limiting unit 201. In particular, a difference (V*−V) between voltage command V* and an output voltage V (output voltage from first battery unit 100A) is subjected to PI control by a PI controller 202. A command current I1*, which is an output signal from PI controller 202, is input to current limiting unit 201. It should be noted that command voltage V* and output voltage V are examples of “command voltage value” and “output voltage value” of the present disclosure, respectively.

Then, a difference between an output signal from current limiting unit 201 and an output current I1 from first battery unit 100A is subjected to PI control by a PI controller 203. First battery unit 100A is controlled based on a pulse signal P1, which is an output signal from PI controller 203.

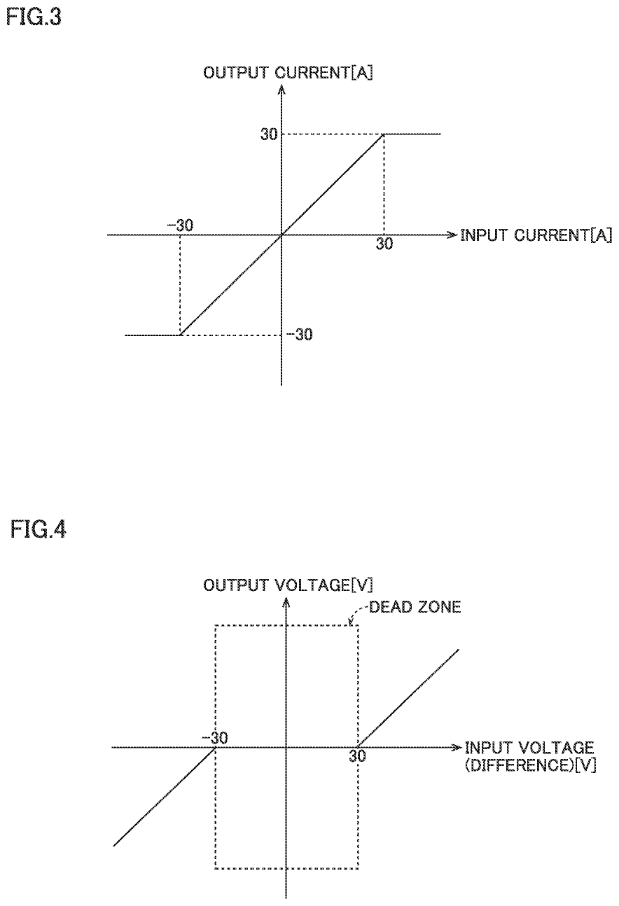

As shown in FIG. 3, in current limiting unit 201, when the input current is equal to or larger than an upper limit (30 A in FIG. 3), the output current is fixed to 30 A. When the input current is equal to or smaller than a lower limit (−30 A), the output current is fixed to −30 A. When the absolute value of the input current is larger than the lower limit and smaller than the upper limit, the output current and the input current are equal in value to each other.

Additionally, in the present embodiment, when the difference (V*−V) between command voltage V* and output voltage V exceeds a predetermined range, control device 200 performs voltage control in accordance with a voltage command in second battery unit 100B. It should be noted that the voltage command and the voltage control in second battery unit 100B are examples of “second voltage command” and “second voltage control” of the present disclosure, respectively.

Specifically, as shown in FIG. 2, control device 200 includes a dead zone processing unit 204. The difference (V*−V) between command voltage V* and output voltage V is input to dead zone processing unit 204.

Then, an output signal from dead zone processing unit 204 is subjected to P control by a P controller 205. A difference between the sum of an output signal from P controller 205 and a command current I2*, and an output current I2 from second battery unit 100B, is subjected to PI control by a PI controller 206. Second battery unit 100B is controlled based on a pulse signal P2, which is an output signal from PI controller 206.

It should be noted that command current I2* is a value determined by dividing a power command (command power P*) by an output voltage (voltage value B) in second battery unit 100B. Command power P* is generated by feedback of power correction. In the feedback, a difference (P-P*) between output power P from first battery unit 100A and command power P* is subjected to PI control by a PI controller 207. Command power P* is a value determined by dividing the sum of an output value from PI controller 207 and a total power execution value of power supply system 1 by the number (N) of battery units 100.

As shown in FIG. 4, in dead zone processing unit 204, when the absolute value of the input voltage (the difference) is equal to or smaller than a set value (30 V in FIG. 4), the output voltage is 0. That is, a dead zone is set in the range of between −30 V and 30 V of the input voltage. When the input voltage (the difference) is larger than 30 V, the output voltage is a value determined by subtracting 30 from the input voltage. When the input voltage (the difference) is smaller than −30 V, the output voltage is a value determined by subtracting −30 from (adding 30 to) the input voltage. The upper limit and the lower limit of the dead zone are equal in value to each other. The range is an example of “predetermined range” of the present disclosure.

In addition, as shown in FIG. 5, control device 200 adjusts the limit value (upper limit and lower limit) in current limiting unit 201 based on command power P*. Specifically, control device 200 increases the absolute value of the upper limit (lower limit) as command power P* increases. In the example shown in FIG. 5, the absolute value changes in proportion to the magnitude of command power P*. It should be noted that command power P* increases as a load capacity of load 30 increases.

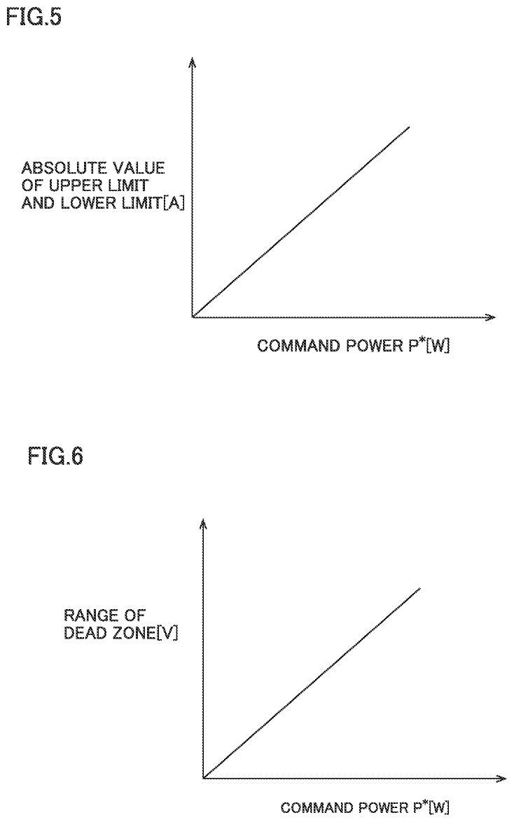

In addition, as shown in FIG. 6, control device 200 adjusts the range of the dead zone in dead zone processing unit 204 based on command power P*. Specifically, control device 200 increases the range (the upper limit and the lower limit in the range) as command power P* increases. In the example shown in FIG. 6, the range changes in proportion to the magnitude of command power P*.

As described above, in the embodiment, control device 200 sets the limit value for a change in electric power in the voltage control of first battery unit 100A, and when the difference between output voltage V and command voltage V* exceeds the predetermined range, control device 200 performs voltage control in accordance with the voltage command in second battery unit 100B. Thus, even in the case where output voltage V changes due to the limit value being set, the change can be suppressed by the voltage control in second battery unit 100B. Therefore, a deviation between output voltage V and command voltage V* can be suppressed while an increase in load on first battery unit 100A is suppressed by the limit on a change in electric power.

Although the range of the dead zone is adjusted based on the magnitude of command power P* in the example of the embodiment, the present disclosure is not limited to this. For example, the range of the dead zone may be constant (fixed value).

Although the limit value (upper limit and lower limit) of current limiting unit 201 is adjusted based on the magnitude of command power P* in the example of the embodiment, the present disclosure is not limited to this. For example, the limit value may be constant (fixed value). For example, the limit value may be equal to allowable power of battery 120.

Although the range of the dead zone increases as command power P* increases (is proportional to command power P*) in the example of the embodiment, the present disclosure is not limited to this. For example, the range of the dead zone may change gradually (in a stepwise manner) based on the relationship in terms of magnitude between command power P* and a predetermined threshold value.

Although the absolute value of the upper limit and the lower limit in current limiting unit 201 increases as command power P* increases (is proportional to command power P*) in the example of the embodiment, the present disclosure is not limited to this. For example, the absolute value may change gradually (in a stepwise manner) based on the relationship in terms of magnitude between command power P* and a predetermined threshold value.

Although an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power supply system comprising:
a plurality of battery units connected to a load in parallel with each other and each including a battery and a converter; and
a control device that controls each of the plurality of battery units,
the plurality of battery units including a first battery unit and a second battery unit, and
the control device
performing first voltage control in accordance with a first voltage command in the first battery unit, and performing power control in accordance with a power command in the second battery unit,
setting a limit value for a change in electric power in the first voltage control, and
when a difference between an output voltage value and a command voltage value exceeds a predetermined range, performing second voltage control in accordance with a second voltage command in the second battery unit.

2. The power supply system according to claim 1, wherein
the control device adjusts the predetermined range based on a command value of the power command.

3. The power supply system according to claim 2, wherein
the control device increases the predetermined range as the command value of the power command increases.

4. The power supply system according to claim 1 wherein
the control device sets the limit value by setting an upper limit and a lower limit on an amount of change in current value in the first voltage control.

5. The power supply system according to claim 4, wherein
the control device increases the predetermined range, and increases an absolute value of each of the upper limit and the lower limit, as the command value of the power command increases.
